(19) United States
(12) Patent Application Publication
(10) Pub. No.: US 2017/0014943 A1
(43) Pub. Date: Jan. 19, 2017

(54) SYSTEM AND METHOD FOR PROCESSING RADIATION DETECTORS USING LASER BEAMS

(71) Applicant: THE GENERAL HOSPITAL CORPORATION, Boston, MA (US)

(72) Inventor: Hamid SABET, Watertown, MA (US)

(21) Appl. No.: 15/121,908

(22) PCT Filed: Feb. 27, 2015
(86) PCT No.: PCT/US15/18105

§ 371 Date: Aug. 26, 2016

Related U.S. Application Data
(60) Provisional application No. 61/946,683, filed on Feb. 28, 2014.

(51) Int. Cl. B23K 26/00; B23K 26/122; B23K 26/53; G01T 1/202; G01T 1/164

(52) U.S. Cl. CPC B23K 26/0057; G01T 1/202; G01T 1/1644; B23K 26/53; B23K 26/122

(57) ABSTRACT

A system, and method, for processing optical materials, such as scintillation materials, using laser beams is provided. In some aspects, the provided system includes a laser system configured to direct a laser beam to a focus in a scintillation material, and a holder configured to engage the scintillation material and position a portion of the scintillation material at the focus. The system also includes a controller configured to drive at least one of the laser system and the holder to form microstructures in the scintillation material having an altered crystal structure.

### CROSS-REFERENCE TO RELATED APPLICATIONS

This application claims the benefit of U.S. Provisional Patent Application Ser. No. 61/945,683 filed on Feb. 28, 2014 and entitled “METHODS AND SYSTEMS FOR PROCESSING RADIATION DETECTORS USING LASER BEAMS.”

### BACKGROUND OF THE INVENTION

The present disclosure relates to radiation detection systems and methods. More particularly, the present disclosure provides systems, methods, and devices for fabricating radiation detectors.

Radiation detection performed in medical and non-medical applications generally utilize detector materials that exhibit scintillation, a process involving luminescence following absorption of incident radiation. Luminescent materials, when struck by an incoming particle, absorb its energy and re-emit the absorbed energy in the form of detectable light. In a radiation detector, scintillator materials are usually coupled to electronic light sensors, such as photomultiplier tubes (“PMTs”), photodiodes, or silicon photomultipliers, which produce measurable electric signals related to the incoming radiation.

Conventional fabrication of scintillator-based radiation detectors generally involves mechanical pixelation. This is a process where multiple scintillator elements are mechanically separated from a monolithic crystal, and subsequently combined, using reflective materials, to produce a detector with high spatial resolution. However, this is a labor-intensive fabrication process with a number of drawbacks. Specifically, mechanically pixelated detectors are associated with a higher cost due to damaged or inferior scintillator elements resulting from mechanical vibrations present during cutting, particularly for thinner materials, as well as due to required post-cutting polishing and processing. Also, the thickness of the diamond blades typically utilized in cutting produce large inter-pixel gaps, or dead areas, resulting in loss of sensitivity to the incident radiation. In addition, fabrication of small pixel arrays can be cost prohibitive, or nearly impossible for pixel sizes smaller than, for example, or area 1×1 mm². Further challenges faced by mechanical pixelation include processing hard or thick materials, as well as hygroscopic materials susceptible to ambient moisture.

Mechanical pixelation has also been attempted using laser machining. Although having improved precision and reduced forces imparted to the material during cutting, this approach is associated with higher costs due to extended laser time required. In addition, the physical removal of material remains a challenge for obtaining high sensitivity detectors, due to the inherent V-shape cut profile leading to increased inter-pixel gap necessary for obtaining pixelation with large aspect ratios, i.e. thickness to cross-section ratio.

An alternative to mechanical separation approaches has involved pixelating scintillators using laser beams. In general, however, efforts have been limited to thinner crystals, of roughly about 5 mm thick. This is because, in general, scintillator materials are brittle, and can easily be fractured. Also, for thicker materials, pixelating processing has been limited to regions far from the crystal edge. This is because fractures occurring at the surface of the scintillator due to interaction of laser beam with air-material interface can propagate throughout the material and damage the structure permanently, reducing yield. In particular, this edge effect has limited the use of laser pixelation in clinical detectors, particular for positron emission tomography (“PET”) detectors requiring scintillators thicker than 15 mm.

Given the above, there is a need for improved radiation detectors for use both in medical and non-medical applications and fabrication thereof. In addition, there is a need for more efficient and economical production of light-producing and/or light channeling devices.

### SUMMARY OF THE INVENTION

The present disclosure provides a system and method for processing optical materials using laser beams, which overcomes the drawbacks of aforementioned technologies.

In one aspect of the disclosure, a system for processing a scintillation material using laser beams is provided. The system includes a laser system configured to direct a laser beam to a focus in a scintillation material, and a holder configured to engage the scintillation material and position a portion of the scintillation material at the focus. The system also includes a controller configured to drive at least one of the laser system and the holder to form microstructures in the scintillation material having an altered crystal structure.

In another aspect of the disclosure, a method for processing a scintillation material using laser beams is provided. The method includes driving a laser system configured to direct a laser beam to a focus in the scintillation material, and positioning a portion of the scintillation material at the focus by controlling a holder configured to engage the scintillation material. The method also includes forming microstructures in the scintillation material having an altered crystal structure by repeatably positioning a different portion of the scintillation material at the focus.

In another aspect of the disclosure, a method for processing an optical material using laser beams is provided. The system includes driving a laser system configured to direct at least one laser beam to a focus, and positioning a portion of an optical material at the focus. The method also includes forming microstructures in the optical material having an altered crystal structure by repeatably positioning different portions of the optical material at the focus.

The foregoing and other aspects and advantages of the invention will appear from the following description. In the description, reference is made to the accompanying drawings that form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 shows a schematic diagram of an example system, in accordance with the present disclosure.

FIG. 2A is an illustration depicting the process of focusing a laser beam insight the volume of a scintillator material, in accordance with aspects of the present disclosure.

FIG. 2B is another illustration depicting the process of focusing a laser beam in proximity to an edge a scintillator material, in accordance with aspects of the present disclosure.

FIG. 3 is a flowchart setting forth steps of a process, in accordance with the present disclosure.

FIG. 4 is a photo depicting fabricated CsI:Tl arrays, in accordance with the present disclosure.

FIG. 5A is a graphical illustration showing example of flood images and line profiles for a 1×1×3 mm³ (top) and a 1×1×5 mm³ (bottom) CsI:Tl pixel array, pixelated in accordance with the present disclosure.

FIG. 5B is a graphical illustration showing example of flood images and line profiles for a 1×1×10 mm³ (top) and a 0.625×0.625×5 mm³ (bottom) CsI:Tl pixel array, pixelated in accordance with the present disclosure.

FIG. 6A is a graphical illustration showing imaging performance, measured using a single slit, of a 0.625×0.625×5 mm³ pixel array, pixelated in accordance with the present disclosure.

FIG. 6B is a graphical illustration showing imaging performance, measured using a triple slit, of a 0.625×0.625×5 mm³ pixel array, pixelated in accordance with the present disclosure.

FIG. 7 is a photo depicting fabricated LYSO:Ce arrays, in accordance with the present disclosure.

FIG. 8 is a graphical illustration showing imaging performance, including energy spectra, flood map and line profiles, for the arrays of FIG. 7.

FIG. 9 is an illustration showing the effect of material thickness on optical barriers, formed in accordance with aspects of the present disclosure.

FIG. 10 illustrates the successful depth correction for thick materials, processed in accordance with aspects of the present disclosure.

### DETAILED DESCRIPTION OF THE INVENTION

The present disclosure is directed to a novel approach for processing optical materials, such as scintillation materials, using laser beams. In some aspects, the present disclosure describes a system, and method, that overcomes the drawbacks of previous technologies attempting to fabricate scintillation-based radiation detectors, and other devices. For instance, the present approach overcomes thickness limitations for the processed materials, and addresses edge effects and fracturing during processing.

As will be appreciated from descriptions below, processed materials, in accordance with the present disclosure, may find use in a variety of applications, including devices or components configured to conserve, direct, or diffuse incident radiation. For instance, features and descriptions of the present disclosure may be applicable to medical imaging systems and methods, such as Positron Emission Tomography (“PET”) systems and methods, Single Photon Emission Computed Tomography (“SPECT”) systems and methods, Computed Tomography (“CT”) systems and methods, and so forth. In addition, the present disclosure may find use in non-medical applications, particularly with respect to devices or components, comprising scintillator and other materials, utilized for radiation detection.

Previous pixelation methods for fabricating radiation detectors using laser beams have been limited to non-hygroscopic materials, such as LYSO, LSO, BGO, and the like. However, there are many important scintillator detectors that utilize hygroscopic materials, which become damaged or change properties when exposed to ambient humidity. For instance, some scintillator detectors may be fabricated using NaI:Tl, NaI:Cs, LaBr₃:Ce, and so forth. For these scintillator detectors, mechanical pixelation has been the only method of pixelation, limiting resolution and at higher fabrication costs. Therefore, as will be described, the present disclosure provides a system and method that extend processing capabilities to hygroscopic materials in addition to non-hygroscopic materials.

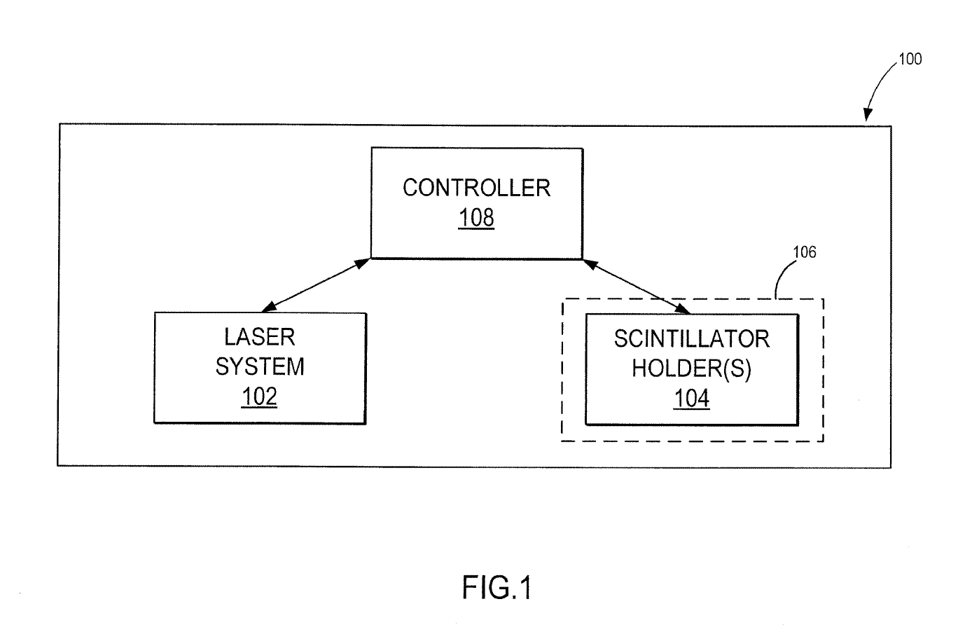

Turning to FIG. 1, a schematic diagram for an example processing system 100 is shown. In accordance with aspects of the present disclosure, the system 100 may be used to process optical materials, such as scintillation materials, and other materials, to form microstructures therein having altered crystal structures. As will be described, such altered crystal structures may serve to provide optical guides or barriers for incident radiation, as well as provide other functionality to processed materials.

As shown in FIG. 1, the system 100 includes a laser system 102, which may include various optical elements, components, and hardware, configured to generate, direct, split, amplify, modulate, diffuse, delay and focus light. For instance, the laser system 102 can include any number of laser sources, beam splitters, beam choppers, lenses, mirrors, delay lines and so forth. In accordance with the present disclosure, such optical elements, components and hardware of the laser system 102 may be configured to generate and movably focus one or more beams of laser light within or proximal to specific regions of targeted materials.

The laser system 102 can include one or more laser source for generating laser beams, each configurable using various selectable laser parameter values, including pulse energy, pulse duration, pulse repetition, laser wavelength, laser energy density, laser power and so on. For example, pulse durations can be in a nanosecond range, or a picosecond range, or a femtosecond range, or combinations thereof. Also, laser wavelengths can be about 532 nanometers, or about 946 nanometers, or about 1064 nanometers. Other laser parameter values may be possible.

In some implementations, the laser system 102 includes a single laser source for generating a laser beam. However, in some applications, multiple laser beams may be required. For example, multiple laser beams may be advantageously utilized in order to process a material at a faster pace, or in order to process multiple material elements substantially concurrently. As such, the laser system 102 may include one or more beam splitters configured to generate a number of laser beams from the laser beam generated using the single laser source. Alternatively, multiple laser sources may be implemented in the laser system 102, generating multiple laser beams, each laser beam potentially configured with different laser parameter values.

In some modes of operation, laser beams generated using different laser sources may be described by different wavelengths and the same pulse duration. In other modes of operation, generated laser beams may be described by different pulse durations and the same wavelength. In yet other modes of operation, generated laser beams may be described by different wavelengths and pulse durations. In addition, different pulse durations may be applied at different regions of the optical material. It may be appreciated that laser beams may be generated using any combination of laser parameters, as described.

Generated laser beams, may then be directed to targeted materials, using any optical elements, components, and/or hardware in order to modify crystal structures therein. For instance, in some configurations, the laser system 102 may include one or more micro-electro-mechanical system (“MEMS”) components configured to direct one or more laser beams to at least one focus.

As shown in FIG. 1, the system 100 also includes at least one holder 104, configured to engage and hold one or more targeted materials, for example, using fasteners or other means for securing materials thereto. The holder 104 may be configured to position at least one portion of a specific material at the focus of one or more laser beams. In some configurations, the holder 104 may be motorized, capable of controllably translating materials secured thereto along one or more directions. By way of example, the holder 104 may be in the form of a linear stage configured to displace materials, for example, at speeds between 0 mm/sec and 100 mm/sec. Other speeds may also be possible. In other configurations, the holder 104 may be stationary.

As mentioned, system 100 may be used for processing hygroscopic scintillation materials, such as LaBr₃:Ce, NaI:Tl, NaI, CLYC, SrI₂ and so on, as well as non-hygroscopic materials, such as LSO, LYSO, GSO, GLuGAG:Ce, GYGAG:Ce, BGO, CsI:Tl and so on. Hence, in some aspects, the system 100 may include an optional housing 106 for controlling the environment or ambient conditions about a scintillation material placed therein. In particular, since hygroscopic materials are susceptible to absorption or adsorption of water molecules found in ambient air humidity, the housing 106 may be in the form of a hermetic enclosure capable controlling, reducing, or eliminating ambient air humidity, such as a dry box, or other suitable enclosure. In some aspects, the housing 106 may be configured to hold materials therein, and include at least one optical window for transmitting laser light thereto. In other aspects, the housing 106 may be configured to hold both materials and the laser system 102 therein.

In yet other aspects, the housing 106 may be in the form of a container configured to hold therein the scintillation material and a liquid having optical properties similar to the scintillation material. Specifically, such liquid may cover the scintillation material, and prevent absorption or adsorption of water molecules found in ambient air humidity. In addition, such liquid may facilitate processing, helping avoid surface cracks as well as edge feature distortions, as will be described. As such, the liquid can be an index of refraction matching liquid, include an oil or an optical gel. In addition, the liquid may possess specific thermal properties, or may be thermally controlled, in order to control heat generated during processing.

In yet other aspects, hygroscopic materials utilized with the system 100 may be entirely or partially encapsulated using a temporary, or permanent, encapsulation layer. Such encapsulation layer would protect the hygroscopic materials from exposure to ambient air conditions. Preferably, encapsulation layers would include optical properties, such as index of refraction, and other properties, similar to the hygroscopic materials such that laser beam power is efficiently utilized.

As shown in FIG. 1, the system 100 also includes a controller 108 configured to drive the laser system 102 and/or the holder 104 to form one or more microstructures in a given material having altered crystal structures relative to the unprocessed material. As described, laser system 102 can include multiple laser sources. As such, the controller 108 may be configured to operate of each laser source, according to selected laser parameters, either sequentially or substantially concurrently.

In some modes of operation, the controller 108 may be configured to control the focus position of the one or more laser beams generated using laser system 102, by controlling the various optical elements, components, and hardware therein. For instance, the controller 108 may operate one or more focusing lenses, and/or one or more micro-electro-mechanical system (“MEMS”) components, or galvo scanner mirror system components, and the like, to direct one or more laser beams to one or more focus positions within a material. In this manner, a laser beam or beams may be repeatably jogged or scanned throughout the volume of any stationary material.

Also, as described, materials may be mounted on a motorized holder 104. As such, in other modes of operation, the controller 108 may be configured to control the motorized holder 104 such that a material or materials thereupon can be translated or displaced along one or more directions relative to one or more stationary laser beams. In yet other modes of operation, the controller 104 may be configured to control or synchronize both a movement of the holder 104 as well as a scanning of the one or more laser beams in order to control the focus positions within various materials. For instance, the controller 104 may include a software platform containing instructions for controlling laser operation and as well as the holder 104 positioning in an automated fashion, requiring no need for user interaction.

In some aspects, the controller 108 may be utilized to generate microstructures in a material having various indices of refractions, and arranged in a manner such that one or more optical barriers to incident radiation are formed therein. In other aspects, the density of the microstructures having a modified index of refraction may vary across the material.

In some aspects, the controller 108 may modify or adjust laser, and other, parameters in dependence of the properties of the targeted material properties, such as geometry, width, thickness, depth, hardness, brittleness, composition and so forth. In addition, the controller 108 may modify or adjust parameters in dependence of the position of one or more focused laser beams in relation to one or more edges of the targeted material.

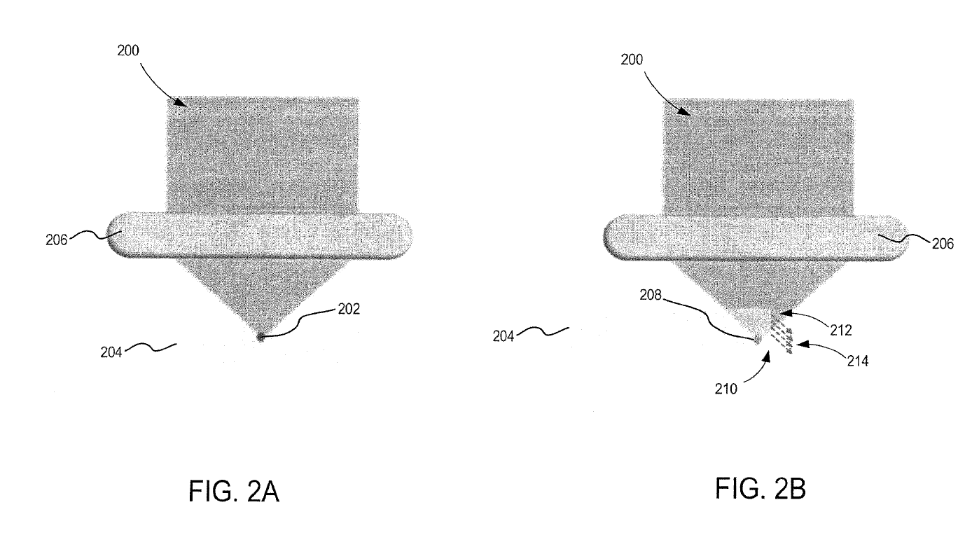

By way of example, a need for position-dependent laser modifications is illustrated in FIGS. 2A and 2B. Specifically, FIG. 2A shows an illustration of a laser beam 200 focused at a point 202 inside the volume of a material 204 using an optical lens 206. FIG. 2B, on the other hand, shown an illustration where the laser beam 200 is focused at another point 208 that is near an edge surface 210 of the material 204. In this case, a portion 212 of the focused laser beam 200 is placed outside the volume of the material 204, resulting in the laser beam 200 being partially reflected from the edge surface 210. Such reflected light 214 is lost to the process, resulting in a weaker focal spot and reduced energy density.

As described, such “edge effect” may be compensated by surrounding the material with a liquid, or other sacrificial material, with an index of refraction that matches the targeted material. In other aspects, the controller 108 may control the beam delivery optics of the laser system 102, such as a MEMS array to avoid the edge effect. In particular, a laser beam may be shaped using a beam chopper and directed through a certain area of the multi-stage optics in the laser system 102, which is configured for processing an edge area of a material. In yet other aspects, laser power, or repetition rate can be increased near edge areas to compensate for loss of energy density.

The system 100, as described above, may be utilized to process one or more provided materials, such as optical materials, scintillation materials, and the like, to form various microstructures therein, the microstructures comprising regions having crystal properties, or crystal structure, modified in comparison to the unprocessed materials. Microstructures having modified crystal properties, or structure, as a result of processing may include, for instance, regions that have transitioned from a crystalline state to an amorphous or glassy state, regions that have obtained one or more crystalline defects or boundaries, regions that have one or more modified lattice constants, regions that have one or more modified crystal directions, and so forth. This may be achieved by controlling the timing and energy deposition of focused laser beams in a manner such that heating and cooling of the affected regions attain the modified crystal properties, or structure.

Formed microstructures within any given material can have any shapes, sizes, and properties, and can be arranged periodically or aperiodically with a given material with any spatial distribution or density. For instance, in some applications, the shape of microstructures can be elongated along the direction of specific laser beams. Such elongated shapes may desirable, for example, for increasing a processing time. In other applications, shapes may be substantially spherical. Also, formed microstructures may be configured to achieve a periodic pixelation of a given material, such as a scintillation material for detecting radiation. Other implementations may include formed microstructures configured and arranged to form waveguides and light diffusers. In some aspects, formed microstructures may form micro-lens features, or microvoids. In other aspects, the shape and properties of formed microstructures may be material dependent. For instance, micro-void structures may be less desirable when processing brittle materials, such as LYSO, or materials belonging to the LSO family for that matter. Such materials would fracture due to micro-explosions required to form micro-void features. This is because these materials have different coefficient of thermal expansion (“CTE”) at different crystal orientation, and fracture very easily.

Modified crystal properties, or crystal structure, describing the microstructures may be uniform or non-uniform throughout the volume of the formed microstructures. For instance, a microstructure can have an index of refraction of 1.0 throughout its volume, while surrounding unprocessed material can have an index of refraction of 1.8. By contrast, crystal properties, or crystal structure, may vary monotonically throughout formed macrostructures. For instance, in the simple case of a spherical microstructure, an innermost volume may have index of refraction of 1.0, while an outermost volume may have an Index similar to the rest of the original material, namely 1.8. The gradient of index of refraction, or pace of change in index, can then be substantially constant between 1.0 to 1.8, for the example given, controllable via optimized laser pulse and focusing lens parameters. Other implementations, may vary between the extremes, namely that the value of the gradient of index of refraction may vary throughout the volume of one or more formed microstructure.

Formed microstructures be utilized, for instance, to form optical barriers that reflect or limit refraction of light incident upon or within the material. In particular, a depth of interaction (“DOI”) describing the spread of incident light in three dimensions may be controlled using formed microstructures. For instance, this may be achieved by varying a density of microstructures, each having similar index of refraction, in a given material. Alternatively, a depth of interaction may be controlled by forming a constant density of microstructures with indices of refraction that can vary within the material.

In some aspects, laser beams generated and directed, in accordance with the present disclosure, may be utilized to modify waveguides, light diffusers, quantum dots, quantum rods, and so forth. For instance, microstructures in quantum dots and rods can be restructured to control the light spread. Also, certain area of light guides or light diffusers can be restructured to control the light spread. In addition, certain areas of a scintillator or other optical component can be restructured to create waveguides. In addition, certain areas of a scintillator or other optical component can be restructured to create photonic bandgap structures to transmit or reflect certain wavelengths.

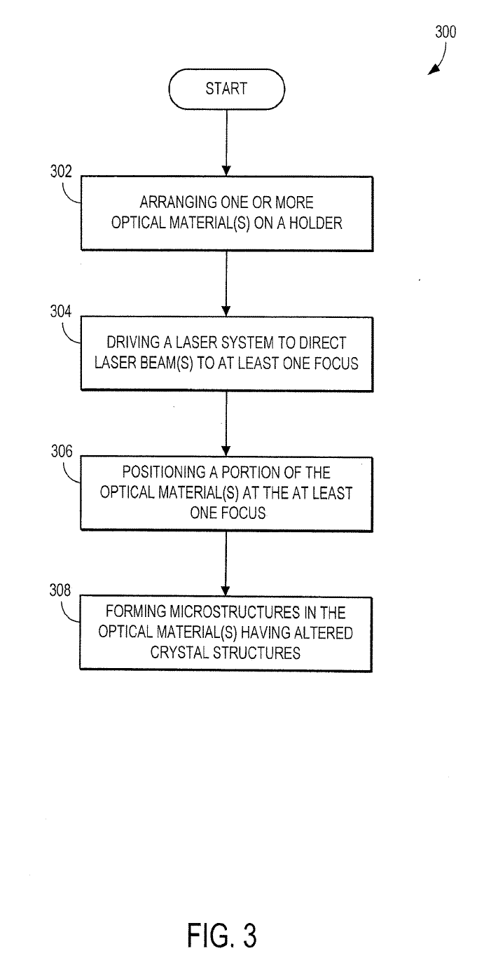

Turning to FIG. 3, a flowchart setting forth steps of a process 300 for processing optical materials, such as scintillation materials, using laser beams are shown. Optical materials can include, for example, LYSO, LSO, BGO, LaBr₃, NaI, CsI in conjunction with any dopants, including Ce, Pr, Na, Tl and so forth. Other materials may also be possible. In particular, steps of the process 300 may be carried out using a system 100 as described with reference to FIG. 1, although it may be appreciated that other suitable systems may be utilized.

The process 300 may begin at process block 302 whereby one or more optical materials may be arranged on, fastened to, or affixed to one or more holders. In some aspects, arranged materials may include hygroscopic and non-hygroscopic scintillation materials. The materials can be placed on the holder(s) in any desired orientation, such as parallel or perpendicular to directions of incident laser beam(s). In addition, arranged optical materials may undergo any number of processing steps at or prior to process block 302, such segmentation, polishing, curing, encasing, and so on.

In some aspects, hybrid materials, consisting of multiple components composed of different materials, for example, optically coupled or glued to each other, may be utilized at process block 302. For example, hybrid materials can include CsI:Tl+LYSO, LYSO+GSO, BGO+CsI, BGO+LSO, and so on. In particular, hybrid materials are used for depth decoding detectors, such as in PET detectors with depth of interaction capability, or positron probes with pulse shape discrimination. In addition, a scintillator can be processed with variation of laser parameters at different scintillator depth to fabricate a scintillation detector with built-in DOI capability. In addition, the density and distribution of laser-affected microstructures can be varied accordingly to achieve DOI. Furthermore, the density at all depths can be the same but the laser energy density can be varied to achieve DOI. In other aspects, an already pixelated scintillator, for example, achieved using a mechanical pixelation process, may be utilized at process block 302. Such pixelated scintillator may benefit from improved spatial resolution, achievable using the system and method disclosed herein.

At process block 304, a laser system, configured to generate, direct and focus one or more laser beams in the arranged optical materials, may be driven, for instance, using a controller, as described with reference to system 100 of FIG. 1. As described, this may include selecting laser parameters and optical component configurations in accordance with the properties of the targeted materials, such as geometry, thickness, depth, hardness, brittleness, composition and so forth. In some aspects, it may be appreciated the index of refraction of materials must also be considered at process block 304. This is because index of refraction of the materials to be processed may be appreciably different as compared to air. For example, for a LYSO material, if a focus location is calculated to be at 1 mm depth, the actual focus spot will be at 1.8 mm because the index of refraction of LYSO 1.81. As such, the laser system may need to be configured to compensate for the index change.

At process block 306, a portion of arranged optical materials may be positioned at the focal position of one or more laser beams. In configurations where multiple materials are processed substantially concurrently using multiple beams, respective portions of each material may be positioned at respective focal positions. Then at process block 308, any number of microstructures may be formed in the optical materials having an altered crystal structure by repeatably positioning different portions of each optical material at the each respective focus. In some aspects, particular portions of any optical material may be exposed to one or more laser beams more than once.

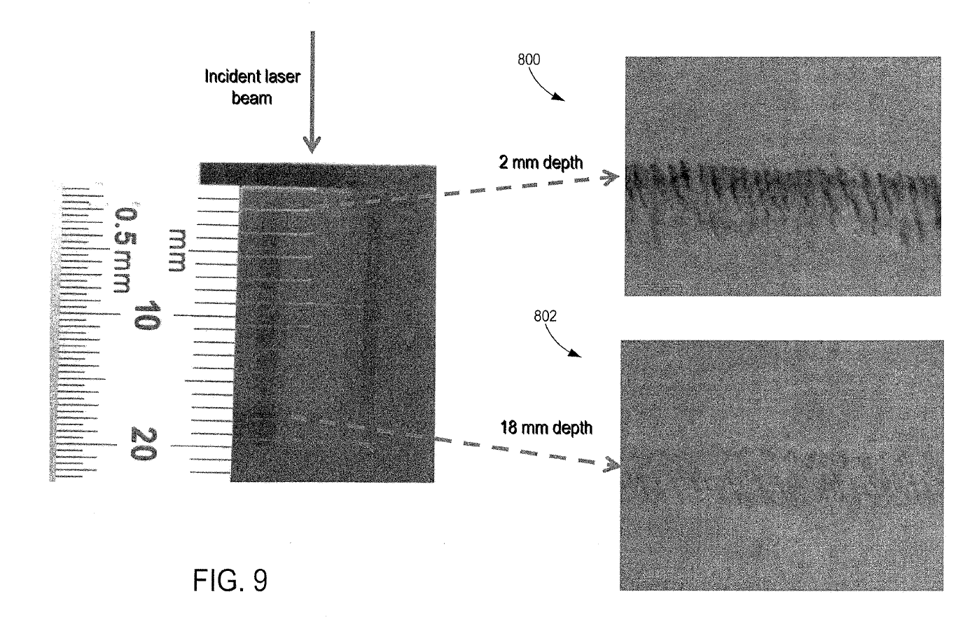

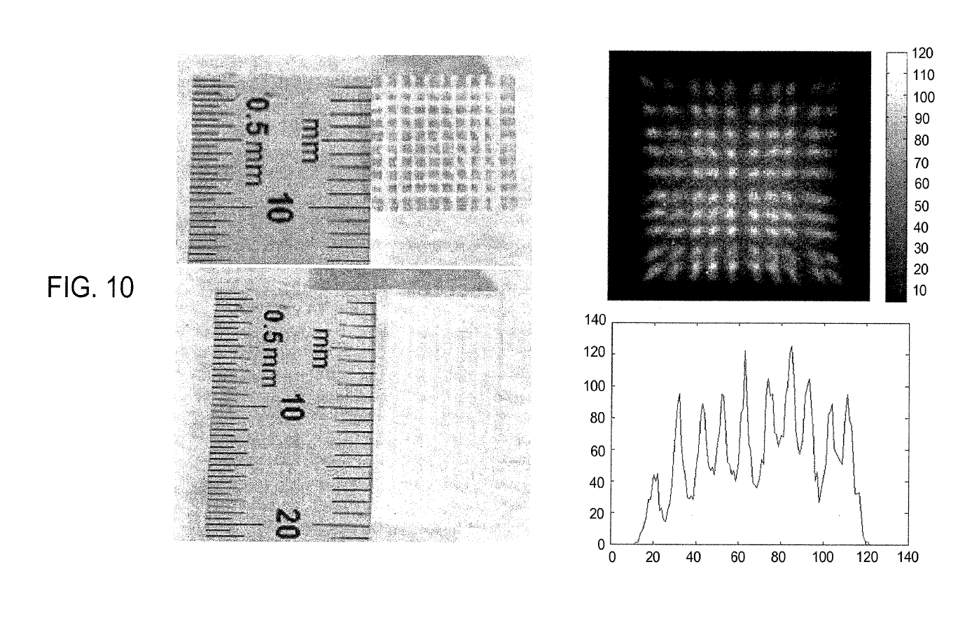

In some aspects, process block 308 may include adapting laser parameters, and other parameters, in dependence of the position of a focused laser beam in relation to one or more edges of the targeted materials. In addition, some applications may require processing thicker materials, such as materials with a thickness greater than 10 mm, and more specifically greater than 20 mm. However, energy deposition can vary with depth as a result of traversal of focused laser beams through more material. This point is illustrated in FIG. 9, where a processed 20 mm thick LYSO material shows a first optical barrier 800 at 2 mm depth, and different, second optical barrier 802 at 18 mm depth. Therefore, if a consistency is desired for the formed microstructures as a function of depth, corrections may need to be applied at process block 308. Specifically, this may be achieved using a number of strategies, including increasing a pulse energy, performing a slower scanning, increasing a repetition rate, or by changing the material orientation by 180 degrees, or any combination thereof. By way of example, FIG. 10 shows pixelated LYSO crystals of size 10×10×20 mm³ and pixel cross-section of 1×1 mm², successfully processed using depth corrections as described, as indicated by flood maps and line profiles shown in FIG. 10.

As described, microstructures formed in each optical material may include a number of periodic or aperiodic optical structures, of any shapes, sizes and spatial distributions. In some applications, a light response function of a slab of scintillation, or other material, may be controlled at process block 308 via a specific distribution or density of microstructures having altered crystal structures. Also, process block 306 may further include controlling either the laser beam directions through scanning, or the positions of the optical material(s) holders, or both.

Also, in some aspects, an optimization process may be performed to obtain microstructures having modified crystal structures within targeted materials, in a controllable manner. Such optimization process may include simulations for working out specific patterns, with desired optical properties, to be defined in various regions of target materials. Then through experimentation and follow-up characterization, optical properties, including index of refraction or reflectivity, of created optical barriers may be measured. For example, the reflectivity of optical barriers can be measured using techniques, such as x-ray phase contrast imaging, refractometer, or ellipsometry, and so forth. Such measurements may lead to subsequent laser processing with more optimized laser parameters. This process can continue until desired properties are achieved.

In some aspects, elements, components, or hardware of laser system 102 may be optimized to modify crystal structures in the targeted materials in a controllable manner. In particular, selected laser source parameters, such as pulse energy, pulse duration, pulse repetition, laser wavelength, laser energy density, laser power and so on, may be optimized. In addition, parameters associated with optical elements, for example, a focusing lens working distance or numerical aperture, or both, may be also be optimized. Other optimized parameters can include laser beam sweep rate, holder displacement rate, and so on. For instance, optimized parameters may be selected to avoid material damage, for example, due to thermal stresses. In other aspects, optimized parameters may be selected in dependence of the properties of the targeted material, such as geometry, thickness, width, depth, hardness, brittleness, composition and so forth. In yet other aspects, optimized parameters may be selected in dependence of the position of a focused laser light in relation to one or more edges of the targeted material.

By way of example, for processing a CsI material mounted on a linear stage running at 70 mm/sec displacement rate, for instance, a laser power of 3.0 Watts measured at the output of a focusing lens, may be utilized. For a 20 mm thick LYSO material, a first 5 mm may be processed using a 3.41 Watts laser power running at 60 mm/sec, a second 5 mm at 3.41 Watts running at 70 mm/sec, a third 5 mm at 3.2 Watts running at 70 mm/sec, and a fourth 5 mm at 2.7 Watts running at 70 mm/sec. Two passes may be utilized, with a distance between the two about 20 microns. This approach can help avoid fractures due to different laser energy density being applied at different depth accordingly. In addition, it may help compensate for loss in beam energy at larger crystal depths. It may be appreciated that other laser source parameters, number of passes, and stage speed may also be possible.

As may be appreciated, the system and method described may facilitate advances in a wide variety of applications. For instance, in one application, elements and features of the present disclosure may applied to produce light diffusers having optical barriers in certain regions of the light diffuser to control the light spread and direction. In another application, optical and/or protective coatings of devices, such as Silicon Photomultipliers (“SiPM”), may be processed. Such laser processing may be used to modify the index of refraction of certain areas of the optical coating to further influence the light spread and its distribution. For instance, a single scintillator pixel may be formed in a larger monolithic scintillator, such as LYSO, to match the SiPM pixels. Then the scintillators will be coupled to a SiPM array such that the formed pixel is aligned with the SiPM pixel. A collimated radiation source may be used to irradiate the carved pixel only. The signal from the associated SiPM divided by the sum of all the neighboring pixels can be used to estimate the effectiveness of the optical barriers and therefore to determine the inter-pixel optical cross-talk. This step may be repeated until the required reflectivity of the optical barriers is achieved.

In yet another application, such laser processing may used to change the index of refraction of certain regions of entrance windows in photomultiplier tubes (“PMT”), facilitated an improved light spread in these photodetectors. In yet another application, the present disclosure may be used to fabricate a pixelated array, where pixels are matched in size with the photodiodes built in the pixels of application specific integrated circuit (“ASIC”). In yet another application, patterns of formed microstructures enable time-of-flight (“TOP”) scintillators, where the light reflection will be directed towards one specific part of the scintillator so that scintillation light can be collected by the photodetector in a faster pace.

Other applications include waveguide fabrication, for use, for example, in phase contrast imaging. In addition, the present disclosure may be used to process materials and devices capable of performing wavelength shifting, including quantum-dot or quantum-rod scintillation devices. Such devices may be processed to include specific regions of modified index of refraction such that light of particular wavelengths may be absorbed or transmitted. Furthermore, the present disclosure may be used in the fabrication of nanostructures, such as photonic bandgap structures. In particular, the approach presented herein allows such structures to be formed at any given depth inside an optical component, such as transparent glass, Lucite, lens, scintillator and so on.

### Examples

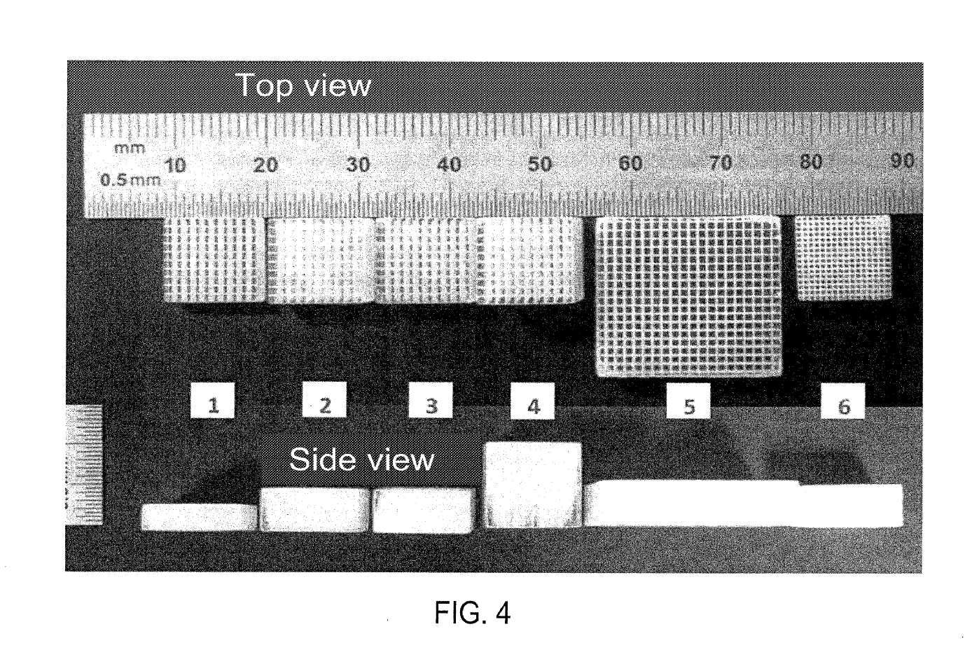

Six polished CsI:Tl crystals of various dimensions were processed to achieve a periodic pixelation, using an approach in accordance with the present disclosure (shown in FIG. 4). The pixelation process was performed using a picosecond laser with a 532 nm wavelength. Using optimized laser parameters, the CsI:Tl crystals were pixelated with 100% yield, in that no material was wasted. Table 1 details the physical properties, including the pixel size, of the CsI:Tl crystals utilized. Specifically, three crystals, namely #2, #3, and #6 were of dimensions 10×10×5 mm³, whereas crystals #1 and #4 were of dimension 10×10×3 mm³ and 10×10×10 mm³, respectively.

TABLE 1
Properties of CsI:Tl crystals

| | Crystal | Pixel | Number | Pixilation |
|---|---|---|---|---|
| Sample | dimension | size | of LIOB | time |
| # | (mm3) | (mm3) | layers | (mm:ss) |
| 1 | 10 × 10 × 3 | 1 × 1 × 3 | 2 | 10:49 |
| 2 | 10 × 10 × 5 | 1 × 1 × 5 | 2 | 19:10 |
| 3 | 10 × 10 × 5 | 1 × 1 × 5 | 1 | 13:08 |
| 4 | 10 × 10 × 10 | 1 × 1 × 10 | 2 | 46:21 |
| 5 | 20 × 20 × 5 | 1 × 1 × 5 | 2 | N/A |
| 6 | 10 × 10 × 5 | 0.625 × 0.625 × 5 | 2 | 30:28 |

As described, a specific light response function of scintillation, and other, materials may be achieved in any number of ways, including performing multiple laser passes to obtain optical walls that determine reflection and transmission of light through the material. Herein, optical walls were produced using laser-induced optical barriers (“LIOB”), which resemble the reflecting materials used in mechanically pixelated arrays. To create each optical wall, a double pass of laser pulses was performed, whereby the laser beam was scanned through the scintillator, then jogged by a certain spacing followed by a second scanning process. Although a 20 micron spacing between passes was utilized for the fabricated CsI:Tl arrays reported here, it may be appreciated that any spacing value may be used.

The crystals were mounted on a XYZ linear stage controlled by a programmable software platform. The software platform was configured to control laser parameters so that the entire process was automated with no human interaction. While the pixel cross-section in CsI:Tl arrays #1 through #5 was 1×1 mm², that of #6 was 0.625×0.625 mm². With the exception of array #3, which was processed by using a single pass of laser pulses per optical wall, the rest of the samples are processed using two passes. The processing time for pixelating each array is also given in Table 1. As shown, it took only about 30 minutes to pixelate a monolithic 10×10×5 mm³ CsI:Tl crystal into 0.625×0.625 mm² pixels (256 pixels) without the need for addition steps, such as scintillator element polishing and reflector placement, as performed in a mechanical pixelation process. Of note is that above processing was performed by scanning a single laser beam. It is contemplated, however, that improvements in processing time, for example, to less than 10 minutes, may be achieved in a number of ways, including using multiple beams, for example, generated using a beam splitter, or multiple sources. Furthermore, the above technique is not limited to periodic pixels. That is, optical barriers can be created in any pattern, and not necessarily in the form of straight walls forming pixelated arrays. Also, processing is not limited to scintillation materials, but may be applicable to other materials, such as transparent materials, which may be used as light guides in Anger-type gamma detectors.

A Hamamatsu S12642-0404PA-50 MPPC was utilized to measure processed crystals, as described, which allows for a smaller inter-MPPC pixel dead space of 0.2 mm. MPPC pixels were 3×3 mm² with 3.2 mm pixel pitch. Note that with this MPPC pixel and pitch size, there will be about ten 1×1 mm² and about twenty six 0.625×0.625 mm² CsI:Tl pixels in the flood maps. A 14×14×1 mm³ GE-214 fused silica was used as light diffuser to spread the scintillation light over multiple MPPCs for accurate position estimation. The detector formed in this manner was mounted on a dedicated interface board (SIB716) from Vertilon, with all 16 MPPC signals being transferred to a Vertilon IQSP482 64-Ch data acquisition system for further processing. A simple Anger logic was utilized as an event position algorithm for acquiring flood images and line profiles of the arrays as a response to a Co-57 radioisotope. There were 200 and 250 bins in the flood images of the arrays with 1×1 and 0.625×0.625 mm² pixels, respectively.

The spatial resolution of an array with 0.625 mm pixels was also measured using slit collimators with adjustable width. In a first experiment, a 0.25 mm thick plastic shim was placed between two 20×10×5 mm³ tungsten slabs such that the slit depth and width were 10 mm and 0.25 mm, respectively. This configuration allowed for exposing only one column of CsI:Tl pixels and objectively measuring the spatial resolution of the detector. In a second experiment, three 0.25 mm shims were inserted between a 1.58 mm thick lead slabs and two tungsten slabs. The images and their associated line profiles through the slits were obtained. Although possible, no temperature compensation technique was utilized to correct for the adverse effects of temperature on MPPC performance.

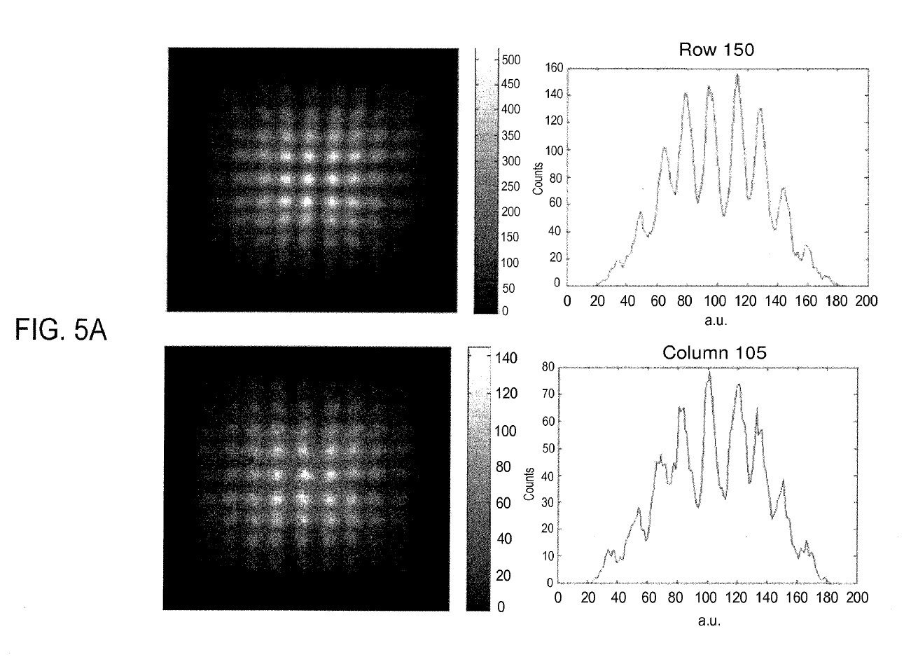

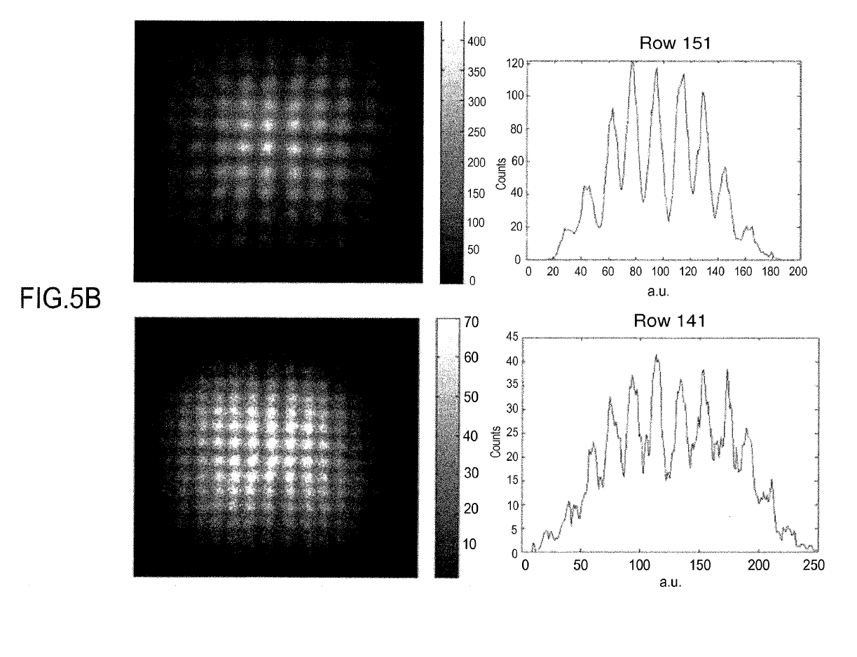

FIGS. 5A and 5B shows the flood images and single line profile for each of the arrays #1, #2, #4 and #6 exposed to a Co-57 radioisotope. The flood maps showed that most of the pixels were resolved, while some of the side pixels were missing, which is mainly due to the geometry of the experiment and the fact that the size of the light guide was larger than that of the MPPC array. This resulted in reduced scintillation light collection, which is more apparent in the edge pixels than the central pixels. The calculated peak-to-valley (“P/V”) ratio of the arrays is summarized in Table 2. Half of the flood images in both directions were analyzed for calculating the P/V. Two average P/V values are reported, one for the entire pixels in the profiles and one for the central pixels in each line profile. For those non-resolved pixels, the P/V was set to 1.

TABLE 2
Peak-to-valley ratio for the CsI:Tl crystals

| | S-1 | S-2 | S-4 | S-6 |
|---|---|---|---|---|
| Total P/V | 2.35 | 2.78 | 3.14 | 2.67 |
| Central P/V | 2.47 | 2.69 | 2.86 | 2.47 |

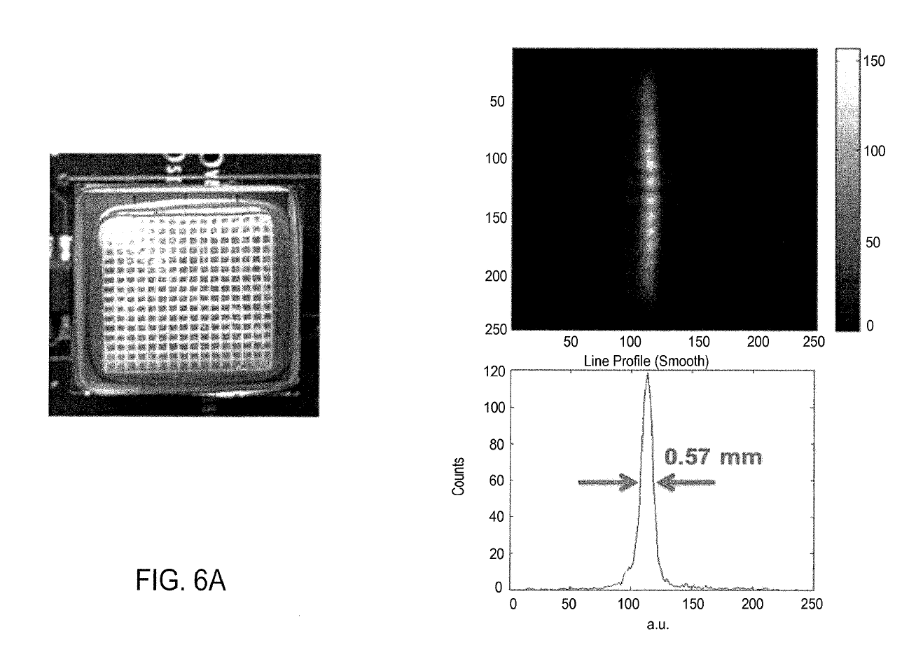

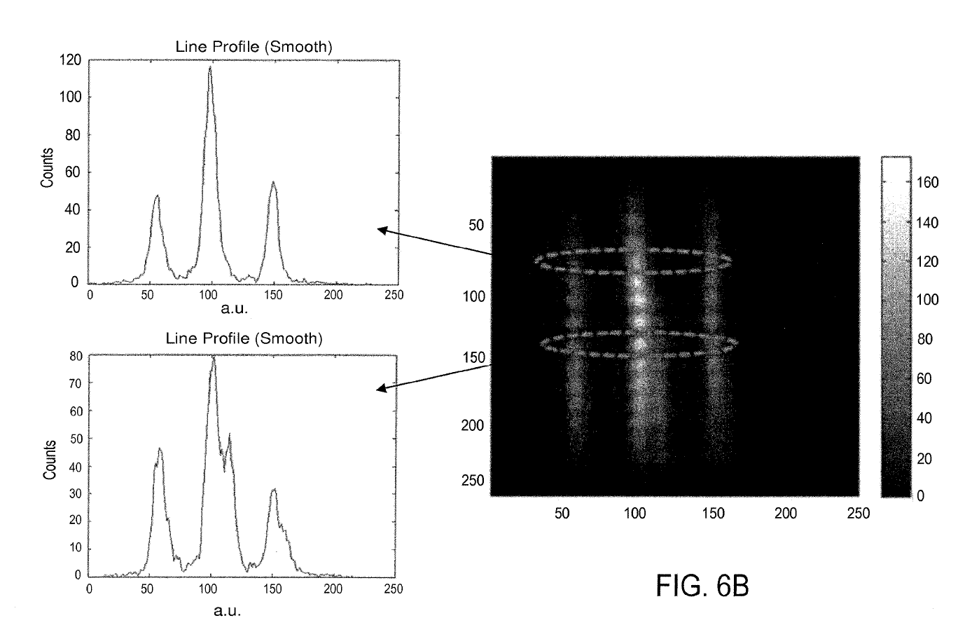

FIGS. 6A and 6B show imaging results of processed crystals bonded to slit collimators (FIG. 6A). Specifically, FIG. 6A shows one column of the CsI:Tl pixels lit up from exposure using a single slit. Of note is that that the slit width was 2.5× smaller than the pixel size, introducing a large tolerance for mispositioning the collimator with respect to the scintillator column. The calculated full width at half maximum (“FWHM”) of multiple line profiles through the slit showed a spatial resolution ranging between 0.57 mm to 0.63 mm. In a triple slit image, as shown in FIG. 6B, similar line measurements were obtained, although results varied slightly between the top and bottom of the image. This was likely due to slight rotation in the collimator with respect to the scintillator array, as demonstrated by the double CsI:Tl columns visible in the bottom half of the image.

A demonstration that high spatial resolution and high sensitivity may be achieved for CsI:Tl arrays and with 100% process yield, in accordance with the present disclosure. The results suggested no significant changes in spatial resolution or P/V degradation when the scintillator thickness was increased. Specifically, 625 micron CsI:Tl pixels were demonstrated to be effectively resolved using an approach afforded by the present disclosure. These results imply that 0.5 mm pixels for high-spatial resolution SPECT-MRI may be achievable at a very low pixelation cost. In addition, the time to pixelate such fine-pitched CsI:Tl array was roughly 30 minutes without human interaction, which is remarkably fast compared with the labor and processing time associated with mechanical pixelation, which includes polishing, and inserting reflectors between scintillator pixels.

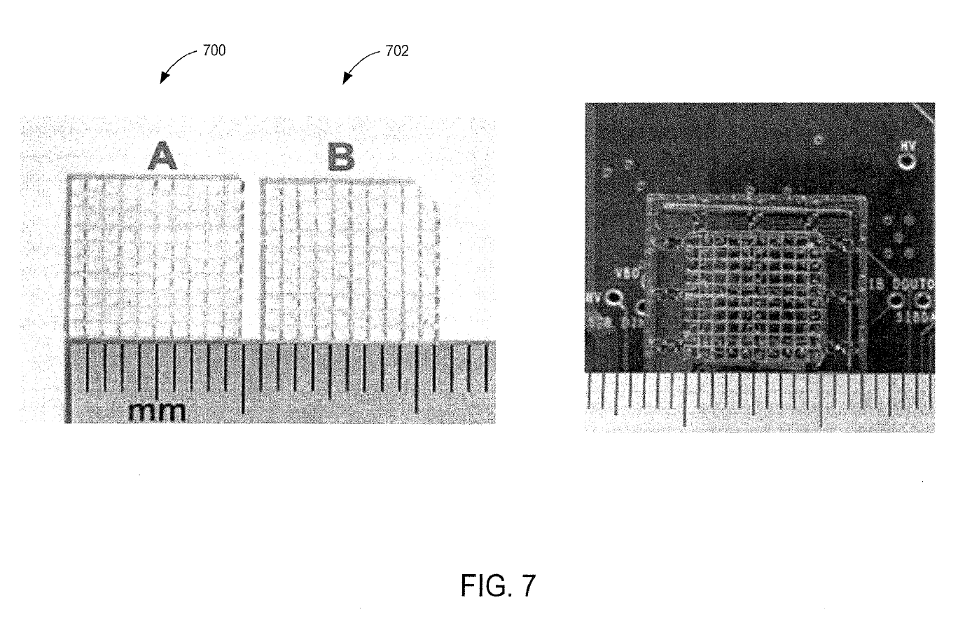

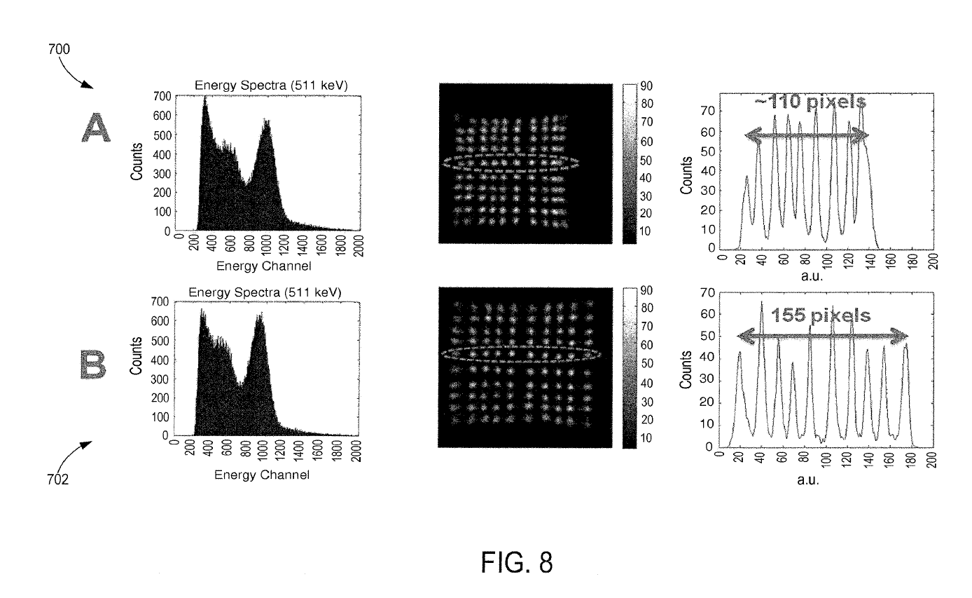

In addition two LYSO:Ce arrays were pixelated using the approach described herein. The arrays were 10×10×1 mm³ each, and were pixelated to 1×1 mm² pixels. The pixelation strategy and laser parameters were kept the same between the two arrays, except for the number of passes for creating the optical barriers. Specifically, the first array 700 (A) was processed with single optical barrier layer and second array 702 (B) was processed with double optical barriers and 10 micron spacing (shown in FIG. 7). The arrays response to Ge-68 (511-keV) calibration gamma source was characterized via acquired energy spectra, flood map, and line profiles. Each array was then coupled to a SensL ArrayB-30050-16P-PCB SiPM using a 1 mm thick light guide. The SiPM was mounted on a dedicated interface board from Vertilon where all 16 SiPM signals were passed to a Vertilon IQSP482 64-Ch data acquisition system. This configuration produced about 17 LYSO pixels per SiPM pixel. Simple Anger logic was utilized as an event position algorithm for the experiments. Measurement results are shown in FIG. 8 for the first array 700 and second array 702. Specifically, The energy spectra of both arrays are similar, with energy resolution measured at 24%. The second array 702 shows superior performance due to its doubled number of optical barriers. In addition the second array 702 shows well resolved pixels, including edge pixels, totaling 155 image pixels.

While an MPPC was used photodetector, it is anticipated that the same trend can be observed using photomultiplier tubes and photodetectors with quantum efficiency that matches with emission wavelength of CsI:Tl (i.e. 550 nm). For the purpose of clarity, a simple centroid method was used to position the gamma-ray events in the flood maps. However, it is conceived that scintillators processed using the approach described herein can further benefit from positioning algorithms, such as maximum likelihood techniques.

Laser processed scintillators, in accordance with the present disclosure, can provide the flexibility, and cost-effectiveness of monolithic crystals as well as high spatial resolution of mechanically pixelated arrays. Since the process described is very robust, any optical pattern may be formed within a given crystal to control and redirect scintillation light in a manner that achieves the best spatial resolution while maintaining the sensitivity.

The present invention has been described in terms of one or more preferred embodiments, and it should be appreciated that many equivalents, alternatives, variations, and modifications, aside from those expressly stated, are possible and within the scope of the invention.

1. A system for processing a scintillation material using laser beams, the system comprising:
a laser system configured to direct a laser beam to a focus in a scintillation material;
a holder configured to engage the scintillation material and position a portion of the scintillation material at the focus; and
a controller configured to drive at least one of the laser system and the holder to form microstructures in the scintillation material having an altered crystal structure.

2. The system of claim 1, the laser system further comprising at least one laser source configured to generate light defined by a pulse energy, or a pulse duration, or a wavelength, or a pulse repetition, or combinations thereof.

3. The system of claim 1, the laser system further comprising at least one focusing lens configured to direct the laser beam to the focus, and defined by a lens numerical aperture, or a lens working distance, or both.

4. The system of claim 2, wherein the pulse duration is in one of a nanosecond range, or a picosecond range, or a femtosecond range, or combinations thereof.

5. The system of claim 2, wherein the wavelength of light is about 532 nanometers, or about 946 nanometers, or about 1064 nanometers.

6. The system of claim 2, the laser system further comprising a beam splitter for generating a plurality of laser beams using the at least one laser source.

7. The system of claim 1, wherein the portion of the scintillation material at the focus includes an edge portion.

8. The system of claim 1, the system further comprising a housing configured for controlling an environment about the scintillation material placed in the housing.

9. The system of claim 8, wherein the housing is further configured to hold therein the scintillation material and a liquid having optical properties similar to the scintillation material.

10. The system of claim 1, the laser system further comprising at least one micro-electro-mechanical system (“MEMS”) component for directing the laser beam to the focus.

11. The system of claim 1, wherein the scintillation material includes a hygroscopic material, or a non-hygroscopic material, or both.

12. The system of claim 1, wherein the microstructures having the altered crystal structure form pixels in the scintillation material.

13. The system of claim 1, wherein the microstructures having the altered crystal structure form an optical barrier to incident radiation in the scintillation material.

14. The system of claim 1, wherein the microstructures having the altered crystal structure form at least one waveguide.

15. The system of claim 1, wherein the microstructures having the altered crystal structure form at least one light diffuser.

16. The system of claim 1, wherein the microstructures in the scintillation material form at least one photonic bandgap structure.

17. The system of claim 1, wherein the altered crystal structure is uniform throughout a volume describing the formed microstructures.

18. The system of claim 1, wherein the altered crystal structure is non-uniform throughout a volume describing the formed microstructures.

19. The system of claim 1, wherein a density of the microstructures having a modified index of refraction varies across the scintillation material.

20. A method for processing a scintillation material using laser beams, the method comprising:
driving a laser system configured to direct at least one laser beam to a focus;
positioning a portion of a scintillation material at the focus;
forming microstructures in the scintillation material having an altered crystal structure by repeatably positioning different portions of the scintillation material at the focus.

21. The method of claim 20, wherein the portion or the different portions of the scintillation material at the focus include an edge portion.

22. The method of claim 20, the method further comprising arranging the scintillation material in a container configured to hold therein a liquid having optical properties similar to the scintillation material.

23. The method of claim 20, the method further comprising controlling an environment within a housing having the scintillation material arranged therein.

24. The method of claim 23, wherein controlling the environment within the housing includes placing therein a liquid having optical properties similar to the scintillation material.

25. The method of claim 20, wherein the scintillation material comprises a hygroscopic material, or a non-hygroscopic material, or both.

26. The method of claim 20, wherein the altered crystal structure is uniform throughout a volume describing the formed microstructures.

27. The method of claim 20, wherein the altered crystal structure is non-uniform throughout a volume describing the formed microstructures.

28. A method for processing an optical material using laser beams, the method comprising:
driving a laser system configured to direct at least one laser beam to a focus;
positioning a portion of an optical material at the focus;
forming microstructures in the optical material having an altered crystal structure by repeatably positioning different portions of the optical material at the focus.

29. The method of claim 28, wherein the optical material forms one of a waveguide or a light diffuser.

30. The method of claim 28, wherein the optical material forms a photodetector or a protective layer of the photodetector.

31. The method of claim 28, wherein the optical material forms an entrance portion of a photomultiplier tube or a microchannel plate.

32. The method of claim 28, the method further comprising modifying one of a quantum-dot scintillator or a quantum rod scintillator using the formed microstructures.

33. The method of claim 28, the method further comprising modifying a photonic bandgap structure using the formed microstructures.

34. The method of claim 28, the method further comprising forming a pixelated radiation detector using the using the formed microstructures.

35. The method of claim 28, wherein the altered crystal structure is uniform throughout a volume describing the formed microstructures.

36. The method of claim 28, wherein the altered crystal structure is non-uniform throughout a volume describing the formed microstructures.
